(19) United States
(12) Patent Application Publication
(10) Pub. No.: US 2017/0341007 A1
(43) Pub. Date: Nov. 30, 2017

(54) ADVANCED DIRECT CONTACT CONDENSER APPARATUS AND METHOD

(71) Applicant: SPX HEAT TRANSFER LLC, Tulsa, OK (US)

(72) Inventors: Chris KLOPP, Topton, PA (US); Gary FEHNEL, Tulsa, OK (US)

(21) Appl. No.: 15/276,078

(22) Filed: Sep. 26, 2016

Related U.S. Application Data
(60) Provisional application No. 62/341,953, filed on May 26, 2016.

(51) Int. Cl. B01D 53/00; F24J 3/08; F01K 9/00; F28B 3/02; B01D 5/00

(52) U.S. Cl. CPC B01D 53/002; F28B 3/02; B01D 5/0027; F01K 9/003; F24J 3/085

(57) ABSTRACT

A direct contact condenser for a steam turbine having an exhaust steam flow hood and a condenser connected to the hood. The condenser includes a downward flow condensing cell having a first liquid distribution assembly a first heat exchange media disposed below the first liquid distribution assembly. The condenser also includes an upward steam flow cooling cell and a second liquid distribution assembly along with a second heat exchange media disposed below the second liquid distribution assembly.

### CROSS-REFERENCE TO RELATED APPLICATION

This application claims priority to and is a non-provisional of U.S. patent application entitled ADVANCED DIRECT CONTACT CONDENSER APPARATUS AND METHOD, filed May 26, 2016, having a Ser. No. 62/341,953, the disclosure of which is hereby incorporated by reference in its entirety.

### FIELD OF THE INVENTION

This invention relates generally to an improved direct contact condenser apparatus for use in a geothermal power plant, and a method of condensing geothermal vapor utilizing same.

### BACKGROUND OF THE INVENTION

Geothermal energy resources are considered by many as an alternative to conventional hydrocarbon fuel resources. Fluids obtained from subterranean geothermal reservoirs can be processed in surface facilities to provide useful energy of various forms. One such form is the generation of electricity by passing geothermal vapor through a steam turbine and turning a generator.

Geothermal fluids typically comprise a variety of potential pollutants, including non-condensable gases such as ammonia, hydrogen sulfide, and methane and therefore discharging geothermal non-condensable gases into the atmosphere. Atmospheric discharge may be prohibited for environmental reasons. Thus, it is common practice to exhaust the turbine effluent into a steam condenser to reduce the turbine back pressure and concentrate the non-condensable gases for further downstream treatment.

Many geothermal power plants utilize direct contact condensers, wherein the cooling liquid and vapor contact one another in a condensation chamber, to cool and condense the vapor exhausted from the turbine. Typically the cooling liquid must be introduced into the condensation chamber at a high enough pressure to disperse the liquid thru nozzles or orifices as fine droplets, i.e., to form a rain, which increases the surface area for vapor contact and condensation. The resulting high velocity discharge can reduce the contact time between the cooling liquid and the vapor, which in turn may reduce the heat exchange efficiency. Consequently, conventional direct contact condensers require relatively large condensing chambers to allow for heat transfer efficiency and to provide sufficient contact time between the liquid and vapor to effect condensation.

One way to increase the condensation efficiency, and thus minimize the size of the direct contact condenser, is to introduce the cooling liquid through a plurality of individual nozzles, which disperse the cooling liquid over structured media in the form of a turbulent film, forming an efficient heat transfer “system.” Because a turbulent film provides greater surface area contact for condensation than normal fine droplet liquid injection, the cooling liquid can be introduced into the chamber at a lower flow rate and a lower injection pressure, i.e., without generating a rain of fine droplets. A lower cooling liquid flow rate is realized in the inherit ability of the “system” to achieve equivalent heat transfer with less water, as demonstrated by a smaller approach temperature of non-condensable gases as they leave the advanced direct contact condenser.

Direct contact condensers have also been designed using packed columns as the liquid-vapor contact medium to improve the efficiency of contact between the vapor and cooling liquid. However, such packed columns may create a complex vapor flow pattern and affect condenser efficiencies.

Another existing direct contact condenser design is known as a tray type direct contact condenser. In this configuration, the direct contact condenser utilizes a series of flat trays with a pattern of perforated holes in the tray floor to form individual streams of cooling water. Each stream of cooling water exposes its circumference to direct contact with the vapor as it exits the tray hole and eventually each stream breaks down into individual droplets which continue to have contact with the vapor and allow condensation to occur. Although this type of condenser does not require high cooling water pressure, it does require a larger volume of cooling water and the small tray holes are subject to fouling.

A drawback to such processes is that non-condensable gases are present in the geothermal vapor. These gases can accumulate in the condensation chamber, thus adversely affect the efficiency of the turbine and/or condenser, and impair overall plant performance. Unless removed, these gases will collect in the condenser, blanketing the condensing surfaces and reducing the surface area for condensation. These accumulated contaminants also increase the pressure within the condensation chamber, thus affecting the turbine back pressure. Accordingly, in order for the condenser to operate efficiently, these gases must be removed.

Another drawback of current direct contact condenser designs is their height and footprint wherein the plant designer must place the condensers at a lower elevation than the turbine. This is typically accomplished by digging a pit within which the condenser sits and operates.

Accordingly, it is desirable to have the turbine effluent to freely flow into direct contact condenser and contact all said heat exchange media, limiting back pressure without the need for a plant designer to construct and dig a pit, lowering the height of the condenser.

### SUMMARY OF THE INVENTION

The foregoing needs are met, to a great extent, by the present invention, wherein aspects of an advanced direct contact condenser are provided.

An aspect of the present invention pertains to a direct contact condenser for a steam turbine exhaust that extends horizontally along an axis, the direct contact condenser comprising: an airflow hood having an inlet end and an outlet end; a condensing chamber connected to said hood, wherein said condensing chamber comprises: a downward flow condensing cell comprising: a first liquid distribution assembly; and a first heat exchange media disposed below said first liquid distribution assembly; an upward steam flow cooling chamber comprising: a second liquid distribution assembly; and a second heat exchange media disposed below said second liquid distribution assembly; and a water collection basin disposed below said condensing and cooling chambers.

Another aspect of the present invention relates to a direct contact condenser for a steam turbine exhaust that extends horizontally along an axis, the direct contact condenser comprising: a condensing chamber connected to said hood, wherein said condenser chamber comprises: a downward flow condensing cell comprising: a first liquid distribution assembly; and a first heat exchange media disposed below said first liquid distribution assembly; an upward steam flow cooling chamber comprising: a second liquid distribution assembly; and a second heat exchange media disposed below said second liquid distribution assembly; and a water collection basin disposed below said chambers, wherein said first liquid distribution assembly and first heat exchange media are positioned a first vertical location along the axis and wherein said second liquid distribution assembly and second heat exchange media are positioned at a second vertical position along the axis above said first position.

Yet another aspect of the present invention relates to a method for condensing turbine effluent using a direct contact condenser, comprising: flowing the turbine effluent through an inlet end of an exhaust steam flow hood having wherein the effluent exits an outlet end to a condensing chamber; flowing the turbine effluent into and through the condensing chamber connected to the hood, wherein said condensing chamber comprises: a downward flow condensing cell comprising: a first liquid distribution assembly; and a first heat exchange media disposed below said first liquid distribution assembly; an upward non-condensable flow cooling chamber comprising: a second liquid distribution assembly; and a second heat exchange media disposed below said second liquid distribution assembly; and flowing the turbine effluent through the first heat exchange media and the second heat exchange media; and dispersing cooling liquid on the first and second heat exchange media as the effluent traverses there through.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the disclosure in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic side view of a direct contact condenser in accordance with an embodiment of the present invention.

FIG. 2 is another schematic side view of a direct contact condenser of another embodiment of this invention.

FIG. 3 is a schematic top view of a steam turbine exhaust hood used in connection with a direct contact condenser in accordance with the embodiment of FIG. 2.

FIG. 4 is a schematic side view of the steam turbine exhaust hood depicted in FIG. 3.

The drawings presented are intended solely for the purpose of illustration and therefore, are neither desired nor intended to limit the subject matter of the disclosure to any or all of the exact details of construction shown, except insofar as they may be deemed essential to the claims.

### DETAILED DESCRIPTION

Various aspects of the present invention provide for an improved direct contact condenser apparatus for use in a geothermal power plant, and a method of condensing geothermal vapor utilizing same. Preferred aspects of the invention will now be further described with reference to the drawing figures, in which like reference numerals refer to like parts throughout.

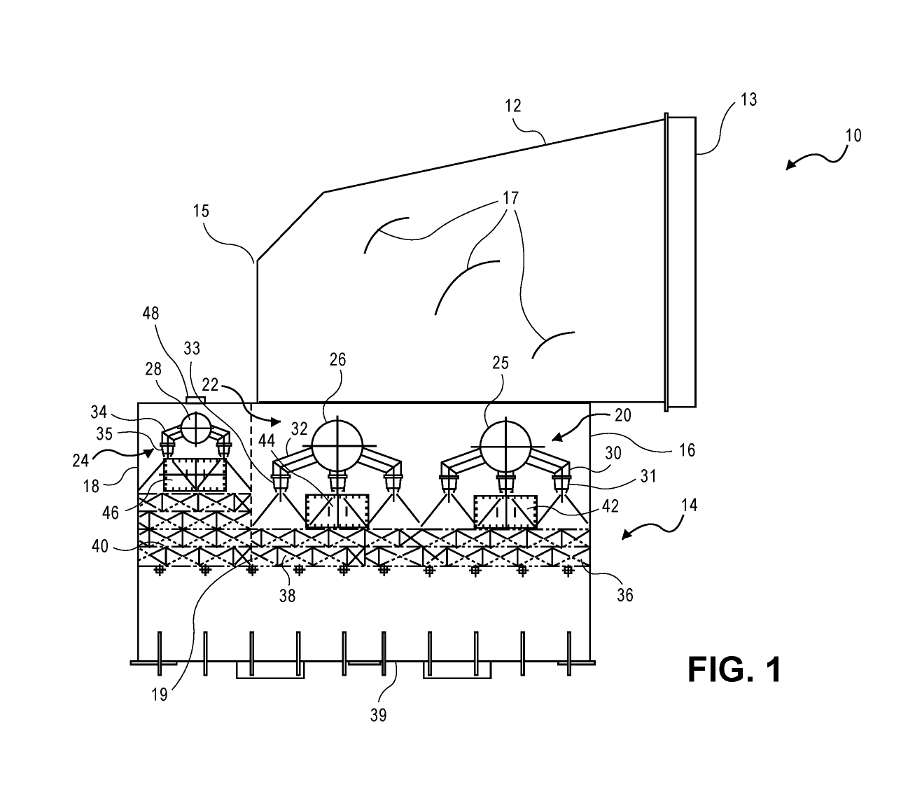

Turning now to the drawings, FIG. 1 is a partial cross sectional view of an improved direct contact condenser apparatus generally designated 10, suitable for use with an aspect of the present invention. As shown in FIG. 1, the improved direct contact condenser apparatus 10 includes exhaust steam flow hood 12 connected to a condensing chamber 16 of the improved direct contact condenser apparatus 10. The exhaust steam flow hood 12 has a first, entrance end 13 and a second, rear end 15 wherein the steam exhaust hood 12 comprises a series of exhaust steam flow vanes 17 disposed therein. As illustrated in FIGS. 1-4, the exhaust steam flow hood 12 is oriented horizontally above the condenser section 14 and directs turbine effluent into the upper section of the condensing chamber 16. Whereas standard direct contact condensers typically direct turbine effluent generally on the same plane as liquid distribution arrangement, the turbine effluent flow of the present invention enters the hood perpendicular and above the liquid distribution arrangements 20, 22.

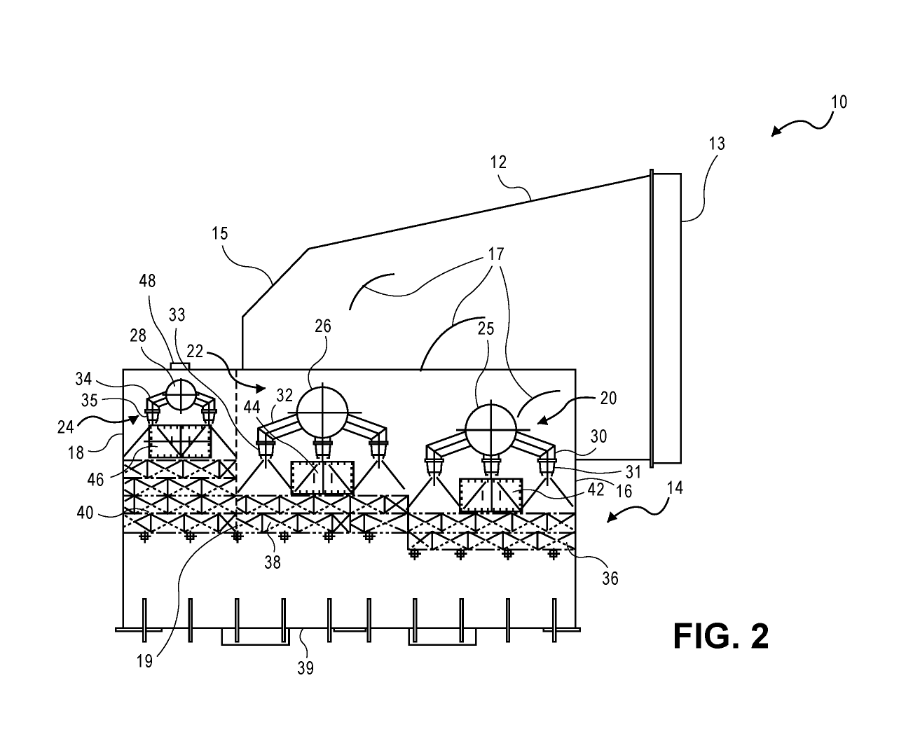

As illustrated in FIGS. 1 and 2, the condenser section 14 has a main condensing chamber 16 and a separate, secondary, cooling chamber 18. More specifically, the condenser section 14 comprises the main condensing chamber 16 also known as a downward steam flow chamber 16 and the secondary cooling chamber 18 also known as an upward steam flow chamber 18 wherein each of said chambers are separated by a wall or partition 19. The downward steam flow chamber 16 comprises liquid distribution arrangements 20 and 22 having a plurality of cooling liquid supply pipes 30, 32, a vapor-liquid contact medium 36, 38 or fill pack, and a well or basin 39. The upward steam flow chamber 18 also comprises a liquid distribution arrangement 24 having a plurality of cooling liquid supply pipes 34, a vapor-liquid contact medium 40 or fill pack, and a well or basin 39.

Although the cooling liquid distribution arrangements 20, 22, 24 depicted in FIGS. 1 and 2 are positioned substantially perpendicular to the longitudinal axis of the housing of the condenser section 14, it will be understood that pipes 30, 32, 34 can be arranged in any suitable orientation relative to housing of the condenser section 14, provided that the pipes 30, 32, 34 distribute the cooling liquid over the entire area of the contact media 36, 38 40. Moreover, as will be further appreciated by one skilled in the art, types of coolant distribution mechanisms and designs other than conduits and/or nozzles may also be utilized to achieve the same function.

Although the embodiment depicted in the figures includes a single downward flow condensing chamber 16 and a single upward flow cooling chamber 18 within the condenser housing of the condenser section 14, it should be understood that the upward flow chamber 18 may be located outside the housing 14, and that the condenser 10 may include a plurality of upward flow chambers 18, within or outside the housing of the condenser section 14.

Finally, it should be understood that a plurality of direct contact condensers may be arranged, as appropriate, to provide sequential treatment for further condensing or cooling the non-condensable gas-steam mixture. Such additional condensers may include both flow chambers 16 and 18, a down flow or a co-current flow chamber 16 and an upward flow chamber 18, or a single upward flow chamber 18. Direct contact condensers may also employ a single or plurality of independent flow chambers 16 and 18.

Turning now to specifically to FIGS. 1 and 2, as previously mentioned, the condenser 10 comprises a main condensing chamber 16 which includes a cooling liquid distribution arrangement 20 and 22 and the secondary, counter current cooling chamber 18 comprising a cooling liquid distribution arrangement 24. Each of the aforementioned arrangements are disposed above the vapor-liquid contact medium 36, 38 and 40 respectively. Turning specifically to the distribution arrangement 20, it includes a cooling liquid supply pipe or header 25 having a series of distribution pipes or branches 30 extending therefrom, wherein the branches 30 supply liquid to nozzles 31 which spray cooling liquid on to the heat exchange media 36. The distribution assembly 22 similarly includes a cooling liquid supply pipe or header 26 having a series of distribution pipes or branches 32 extending therefrom, wherein the branches 32 supply cooling liquid to nozzles 33 which distribute cooling liquid on to the heat exchange media 38. Also similarly, the distribution arrangement 24 includes a cooling liquid supply pipe or header 28 having a series of spray distribution or branches 34 extending therefrom, wherein the branches 34 supply liquid to nozzles 35 which distribute cooling liquid on to the heat exchange media 40.

The condenser apparatus 10 contains a series of access doors 42, 44 and 46. Said access doors provide entrance to each chamber for inspection and maintenance. Said access doors are also of sufficient size to allow the passage of the individual packs of heat exchange media to pass through for installation and maintenance.

Referring to FIG. 2, the spray media and the respective liquid distribution arrangements 20, 22, are each cascaded or stepped to allow for lower entrance of the turbine effluent into the housing of the condenser section 14. Furthermore, such arrangement allows for the better entry and turning of the effluent along with maintaining better velocity flow of the turbine effluent with reduced pressure drop.

The vapor-liquid contact medium 36, 38, 40 or fill pack depicted in FIGS. 1 and 2, is preferably structured media in a fill pack form or geometry. Generally speaking, a wide variety of structured media may be utilized wherein the crimp height spacing of said media will vary. Moreover, the structured media may be constructed from any desirable media such as metals, plastics or the like. However one preferred structured media design and geometry of the present invention is metal in construction and comprises a nominal inclination angle of sixty degrees (60°) from horizontal and is used where high capacity and low pressure drop characteristics are desired.

As previously mentioned, the vapor-liquid contact medium can encompass varying designs and structures having a wide variety of the sizes and geometries. One example of such medium comprises vertically oriented sheets with the corrugations at an angle to the vertical axis. In such arrangements, the sheets are arranged such that the corrugation direction of adjacent sheets is reversed. The packing may be installed in layers which are generally between 6 and 12 inches in height. The packing may have a square or brick geometry oftentimes formed by fixing individual sheets together using adhesives, rods that pierce all of the sheets, or frames which contain and support sheets. Such packing oftentimes has corrugations that are characterized by the crimp height and the base length.

While all corrugated sheet structured packings share the above-described features, there are a large number of variations available commercially. Variations include the use and size of perforations in the packing sheets and the type of surface texture applied to the sheets. The packing or media is made in several sizes as characterized by the specific surface area (area of surface per unit volume). Different sizes are achieved by variation of the crimp height and the base length. For example, reducing the crimp height increases the surface area per unit volume. The use of higher specific surface area packing reduces the height of packing required for a given separation but allowable fluid velocities are decreased. Thus a larger cross-sectional area for flow is required.

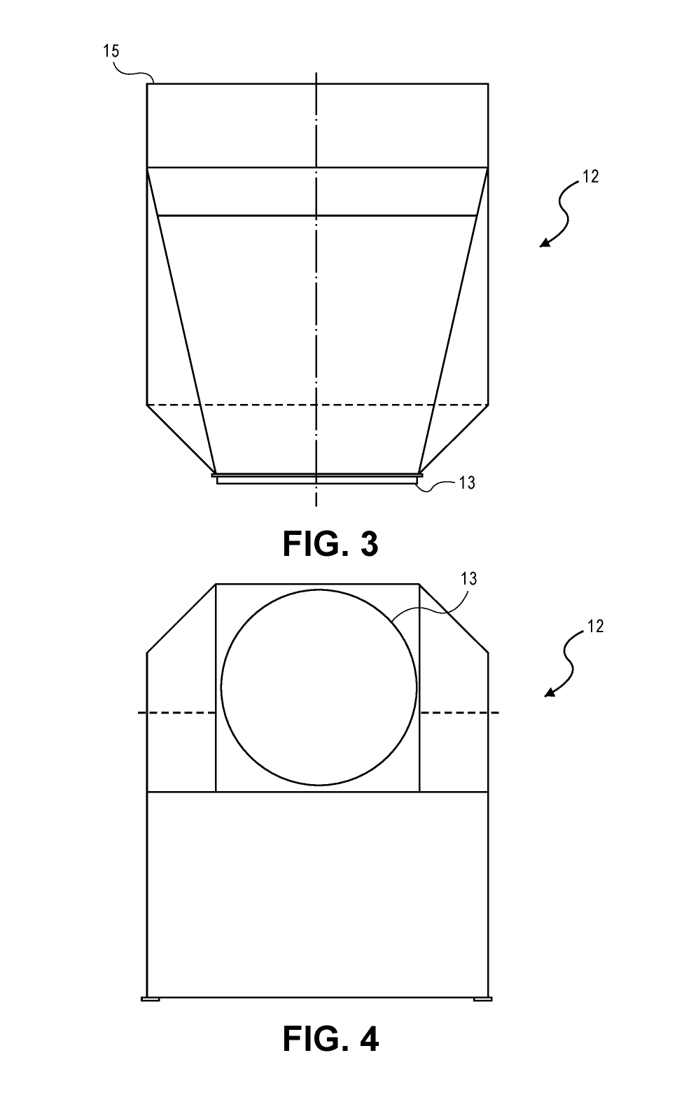

Finally, turning specifically to FIGS. 3 and 4, as previously discussed the improved direct contact condenser apparatus 10 includes an exhaust steam flow hood 12 connected to condensing chamber 16 of the improved direct contact condenser apparatus 10. The exhaust steam flow hood 12 has a first, entrance end 13 and a second, rear end 15 wherein the steam exhaust hood 12 comprises a series of turning vanes 17 disposed therein. The steam exhaust hood 12 allows for steam exhaust entrance of the improved direct contact condenser 10 to be in line with lower elevations of the turbine exhaust opening, while providing improved vapor distribution to the condensing chamber 16 i.e., allowing the turbine effluent to expand and enter the heat exchange media evenly.

As illustrated in FIG. 3, the steam exhaust hood has a configuration or geometry wherein it is similar in size to the steam turbine exhaust at the opening at the first end 13 and extends along a plane toward the second end 15. As illustrated, the exhaust steam flow hood 12 tapers outward and downward, out of the plane, as it extends to the second end 15. Specifically, the inlet 13 is circular in geometry and transitions to a rectangular and/or square geometry wherein said rectangular geometry inscribes the circular geometry. Moreover, the inlet 13 of the exhaust steam flow hood 12 further includes wings that taper out of the plane as they extend to the second end from the inlet 15. This above-described tapering or sloping geometry, extends over the plan of the condensing chamber 16, helping to turn and distribute the turbine exhaust flow, and thus reducing the likelihood of flow eddies and associated pressure drop.

While aforementioned tapering geometry is depicted in a preferred embodiment, the exhaust steam flow hood 12 may have varying geometries and shapes depending upon need. Also as illustrated, the exhaust steam flow hood 12 of the advanced direct contact condenser 10 has an entrance centerline elevation which is in line with the turbine centerline, allowing for clearance with the heat exchange packing and structure sitting below the bottom of the inlet duct as the duct enters directly above the condenser internals. With this preferred embodiment, the two centerlines will be at the same elevation, reducing the need for a pit for the condenser and reducing some of the associated costs with installation. Moreover, the diffuser type design of the exhaust steam flow hood 12 functions to lower the associated entrance losses and decrease the overall pressure drop while allowing the condenser to be designed with a smaller required area and overall footprint, which will again reduce the costs to the end user and improved turbine performance.

During operation, when the steam turbine (not pictured) and the direct contact condenser 10 are in the operating state, the turbine exhaust effluent in the horizontal direction and the steam and non-condensable gases are introduced to the direct contact condenser 10. In the direct contact condenser 10, the turbine exhaust gases are introduced through the exhaust gas inlet part 13 of the exhaust steam flow hood 12, while maintaining the initial flow direction in the horizontal direction the gases are then turned or directed via the flow vanes 17 to the condensing chamber 16. The turbine exhaust gases are supplied to the condensing chambers 16 in a downward flow configuration. The cooling water is then distributed from the first cooling water spraying mechanism 20 onto the packing, causing part of the steam in the turbine exhaust gases to be cooled and to become condensed water and combining with the cooling spray water is collected in the water basin 39. The cooling water sprayed from the second cooling water spraying mechanism 22 onto the packing also causes part of the steam in the turbine exhaust gases to be cooled and to become condensed water and combining with the cooling spray water is also collected in the water basin 39.

Most of the steam is eliminated as condensed water in the downward condensing section 16 however any remaining non-condensable gases and steam in the turbine exhaust gases then proceeds to the secondary, counter current condensing cell 18 through the opening at the bottom of the partition or wall 19. Accordingly, more steam is condensed and the non-condensable gases are cooled, and then exhausted to the exterior through exhaust port 48 with a vacuum system (not shown).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A direct contact condenser for a steam turbine that extends horizontally along an axis, the direct contact condenser comprising:
an exhaust steam flow hood having an inlet end and an outlet end;
a condenser connected to said hood, wherein said condenser comprises:
a downward flow condensing cell comprising:
a first liquid distribution assembly; and
a first heat exchange media disposed below said first liquid distribution assembly;
an upward steam flow cooling cell comprising:
a second liquid distribution assembly; and
a second heat exchange media disposed below said second liquid distribution assembly; and
a water collection basin disposed below said condensing/cooling chambers.

2. The direct contact condenser according to claim 1, wherein the downward flow condensing cell further comprises:
a third liquid distribution assembly; and
a third heat exchange media disposed below said third liquid distribution assembly.

3. The direct contact condenser according to claim 2, wherein said first liquid distribution assembly and first heat exchange media are positioned a first vertical location along the axis and wherein said second liquid distribution assembly and second heat exchange media are positioned at a second vertical position along the axis above said first position.

4. The direct contact condenser according to claim 3, wherein third liquid distribution assembly and third heat exchange media is positioned at a third vertical position along the axis wherein said third position is located vertically above said first position and vertically equal to or different from said second position.

5. The direct contact condenser according to claim 1, wherein said steam exhaust hood comprises at least one exhaust steam flow vane.

6. The direct contact condenser according to claim 5, wherein said at least one exhaust steam flow vane is a plurality of exhaust steam flow vanes.

7. The direct contact condenser according to claim 2, wherein each of said first, second and third heat exchange media is structured vapor-liquid contact media.

8. The direct contact condenser according to claim 7, wherein each of said first, second and third structured vapor-liquid contact media has a nominal inclination angle of sixty degrees (60°).

9. The direct contact condenser according to claim 1, wherein said first liquid distribution assembly comprises a series of spray conduits for dispersing cooling liquid on said media and said second liquid distribution assembly comprises a serious of distribution conduits for dispersing cooling on said media.

10. The direct contact condenser according to claim 1, wherein said inlet end has a circular geometry that transitions to a rectangular geometry.

11. The direct contact condenser according to claim 10, wherein said rectangular geometry inscribes said circular or rectangular geometry of upstream duct.

12. The direct contact condenser according to claim 11, wherein said exhaust steam flow hood further comprises wings, wherein said wings extend generally outwardly and downwardly from said inlet end toward said outlet end.

13. A direct contact condenser for a steam turbine that extends horizontally along an axis, the direct contact condenser comprising:
a condensing chamber connected to said hood, wherein said condensing chamber comprises:
a downward flow condensing cell comprising:
a first liquid distribution assembly; and
a first heat exchange media disposed below said first liquid distribution assembly;
an upward steam flow cooling cell comprising:
a second liquid distribution assembly; and
a second heat exchange media disposed below said first liquid distribution assembly; and
a water collection basin disposed below said cooling chamber,
wherein said first liquid distribution assembly and first heat exchange media are positioned a first vertical location along the axis and wherein said second liquid distribution assembly and second heat exchange media are positioned at a second vertical position along the axis above said first position.

14. The direct contact condenser according to claim 13, wherein the downward flow condensing cell further comprises:
a third liquid distribution assembly; and
a third heat exchange media disposed below said third liquid distribution assembly.

15. The direct contact condenser according to claim 14, wherein third liquid distribution assembly and third heat exchange media is positioned at a third vertical position along the axis wherein said third position is located vertically above said first position and vertically equal to or different from said second position.

16. The direct contact condenser according to claim 15, further comprising an exhaust steam flow hood having an inlet end and an outlet end.

17. The direct contact condenser according to claim 16, wherein said exhaust steam flow hood comprises at least one exhaust steam flow vane.

18. The direct contact condenser according to claim 17, wherein said at least one exhaust steam flow vane is a plurality of exhaust steam flow vanes.

19. The direct contact condenser according to claim 14, wherein each of said first, second and third heat exchange media is structured vapor-liquid contact media.

20. The direct contact condenser according to claim 19, wherein each of said first, second and third structured vapor-liquid contact media has a nominal inclination angle of sixty degrees (60°).

21. The direct contact condenser according to claim 13, wherein said first liquid distribution assembly comprises a series of spray conduits for dispersing cooling liquid on said media and said second liquid distribution assembly comprises a series of spray conduits for dispersing cooling liquid on said media.

22. The direct contact condenser according to claim 16, wherein said inlet engages a turbine or duct and receives turbine effluent.

23. A method for condensing turbine effluent using a direct contact condenser, comprising:
flowing the turbine effluent through an inlet end of an exhaust steam flow hood having wherein the effluent exits an outlet end to a condenser;
flowing the turbine effluent into and through the condenser connected to the exhaust steam flow hood, wherein said condenser comprises:
a downward flow condensing cell comprising:
a first liquid distribution assembly; and
a first heat exchange media disposed below said first liquid distribution assembly;
an upward steam flow condensing cell comprising:
a second liquid distribution assembly; and
a second heat exchange media disposed below said second liquid distribution assembly; and
flowing the turbine effluent through the first heat exchange media and the second heat exchange media; and
distributing cooling liquid on the first and second heat exchange media as the effluent traverses there through.
